(19) United States
(12) Patent Application Publication
(10) Pub. No.: US 2016/0014123 A1
(43) Pub. Date: Jan. 14, 2016

(54) APPARATUS AND METHOD FOR VERIFYING INTEGRITY OF APPLICATIONS

(71) Applicant: ELECTRONICS AND TELECOMMUNICATIONS RESEARCH INSTITUTE, Daejeon (KR)

(72) Inventors: Incheol SHIN, Daejeon (KR); Sinkyu KIM, Daejeon (KR)

(21) Appl. No.: 14/696,161

(22) Filed: Apr. 24, 2015

(30) Foreign Application Priority Data
Jul. 10, 2014 (KR) 10-2014-0086606

(51) Int. Cl. H04L 29/06

(52) U.S. Cl. CPC H04L 63/0876; H04L 63/168; H04L 63/145

(57) ABSTRACT

The present invention relates to an apparatus and method that verify the integrity of applications installed on a smart device by using hash values of application information and related data securely stored in a cloud space, without installing an antivirus program that requires additional complicated operations. The method includes, when a terminal accesses the application integrity verification apparatus, receiving at least one initial value corresponding to an application currently being executed on the terminal from a given application developer server and then generating at least one reference hash value, receiving, from the terminal, at least one application hash value generated based on the application currently being executed on the terminal and data corresponding to the application, comparing the reference hash value with the application hash value, and verifying integrity of the application based on results of the comparison between the reference hash value and the application hash value.

### CROSS REFERENCE TO RELATED APPLICATION

This application claims the benefit of Korean Patent Application No. 10-2014-0086606 filed Jul. 10, 2014, which is hereby incorporated by reference in its entirety into this application.

### BACKGROUND OF THE INVENTION

1. Technical Field

The present invention relates generally to an apparatus and method for verifying the integrity of applications and, more particularly, to an apparatus and method that verify the integrity of applications installed on a smart device by using hash values of application information and related data securely stored in a cloud space, without installing an antivirus program that requires additional complicated operations on the smart device.

2. Description of the Related Art

Recently, there have been an increasing number of cases where malicious code for achieving a malicious purpose is inserted into an application downloaded from a smart device application (App) store using repackaging technology and then the application is transformed into a normal application to leak personal information of a smart device user.

Therefore, measures for protecting a smart phone from various types of malicious codes are required.

For example, Korean Patent Application Publication No. 10-2013-0052246 entitled “System and Method for Verifying Smart Phone Application” presents a system including an application (App) automatic verification device that configures a scenario by analyzing a setup file of an application to be installed on a smart phone, executes the application on the smart phone depending on the scenario, and determines malicious behavior using the results of execution, and an App self-verification device that monitors the setup file corresponding to the application installed on the smart phone, analyzes behavior log corresponding to the results of monitoring, and then determines malicious behavior.

Further, to detect behavior such as infection with malicious code even on a smart device, antivirus programs exclusive to smart devices have been developed.

However, such an antivirus program exclusive to smart devices has a burden in that an antivirus program must be additionally installed on a smart device. Further, there is a disadvantage in that the consumption of battery power and memory capacity of a smart device is increased due to the installation and execution of the antivirus program on the smart device.

### SUMMARY OF THE INVENTION

Accordingly, the present invention has been made keeping in mind the above problems occurring in the prior art, and an object of the present invention is to provide an apparatus and method that verify the integrity of applications installed on a smart device by using hash values of application information and related data securely stored in a cloud space, without installing an antivirus program that requires additional complicated operations on the smart device.

In accordance with an aspect of the present invention to accomplish the above object, there is provided a method for verifying integrity of applications (Apps), including when a terminal accesses the application integrity verification apparatus, receiving at least one initial value corresponding to an application currently being executed on the terminal from a given application developer server and then generating at least one reference hash value; receiving, from, the terminal, at least one application hash value generated based on the application currently being executed on the terminal and data corresponding to the application; comparing the reference hash value with the application hash value; and verifying integrity of the application based on results of the comparison between the reference hash value and the application hash value.

Generating the reference hash value may include generating the reference hash value using an initial value corresponding to an application that is not infected with malicious code.

Verifying the integrity of the application may include, if the reference hash value is identical to the application hash value, determining that the application has integrity.

Verifying the integrity of the application may include, if the reference hash value is not identical to the application hash value, determining that the application does not have integrity.

Verifying the integrity of the application may include providing results of verifying the integrity of the application to the terminal.

In accordance with another aspect of the present invention to accomplish the above object, there is provided an apparatus for verifying integrity of applications, including a reference hash value generation unit for receiving at least one initial value corresponding to an application currently being executed on a terminal from a given application developer server and then generating at least one reference hash value; and a hash value comparison unit for comparing at least one application hash value received from the terminal with the reference hash value, and verifying integrity of the application currently being executed on the terminal based on results of the comparison.

The reference hash value generation unit may generate the reference hash value using an initial value corresponding to an application that is not infected with malicious code.

The hash value comparison unit may be configured to, if the reference hash value is identical to the application hash value, determine that the application has integrity.

The hash value comparison unit may be configured to, if the reference hash value is not identical to the application hash value, determine that the application does not have integrity.

The apparatus may further include a result transmission unit for providing, from the hash value comparison unit, results of verifying the integrity of the application currently being executed on the terminal to the terminal.

The hash value comparison unit may receive, from the terminal, the application hash value generated based on the application currently being executed on the terminal and data corresponding to the application.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an environment to which an apparatus for verifying the integrity of applications according to an embodiment of the present invention is applied;

FIG. 2 is a configuration diagram schematically showing an application developer server according to an embodiment of the present invention;

FIG. 3 is a configuration diagram schematically showing a terminal according to an embodiment of the present invention;

FIG. 4 is a configuration diagram showing an apparatus for verifying the integrity of applications according to an embodiment of the present invention; and

FIG. 5 is a flowchart showing a method for verifying the integrity of applications according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, an apparatus and method for verifying the integrity of applications according to embodiments of the present invention will be described in detail with reference to the attached drawings.

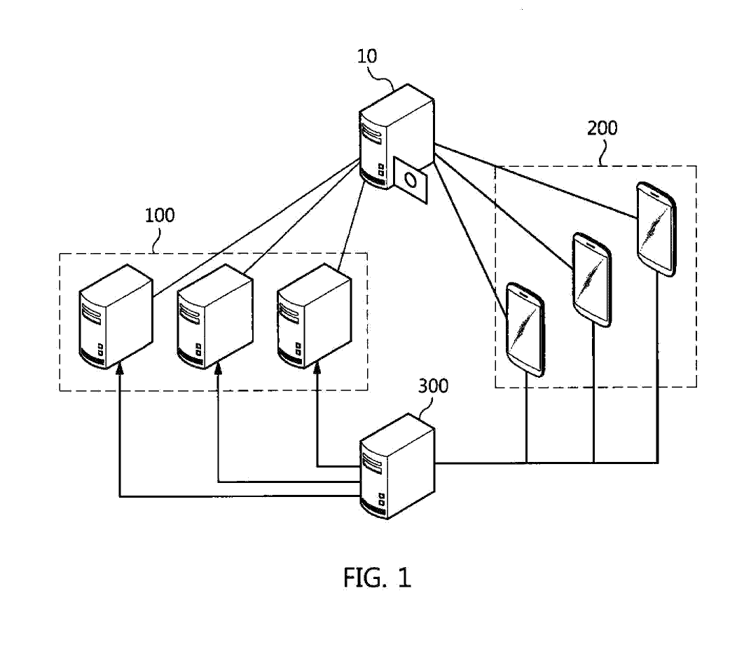

FIG. 1 is a diagram showing an environment to which an apparatus for verifying the integrity of applications according to an embodiment of the present invention is applied.

Referring to FIG. 1, the environment to which the apparatus for verifying the integrity of applications (Apps) according to the embodiment of the present invention is applied includes at least one App developer server 100, an App registration server 10, at least one terminal 200, and an apparatus 300 for verifying the integrity of Apps (hereinafter referred to as an “App integrity verification apparatus 300”). Here, the App integrity verification apparatus 300 is operated in conjunction with the at least one App developer server 100 and the at least one terminal 200.

Each App developer server 100 may register a developed App in the App registration server 10, and the user of the at least one terminal 200 accesses the App registration server 10 through the corresponding terminal, downloads a required App from the App registration server 10, and installs the App.

Each terminal 200 corresponds to, but is not limited to, a smart device. Each terminal 200 executes the App received from the App registration server 10, and generates hash values of the executed App and data corresponding to the App (hereinafter referred to as “App hash values”).

The App integrity verification apparatus 300 compares App hash values corresponding to the App currently being executed on the accessing terminal 200 with reference hash values, and verifies the integrity of the App depending on the results of comparison. Here, the reference hash values correspond to hash values generated based on the App registered in the App developer server 100 and data corresponding to the App before the App is executed on the terminal 200, in order to verify the integrity of the App.

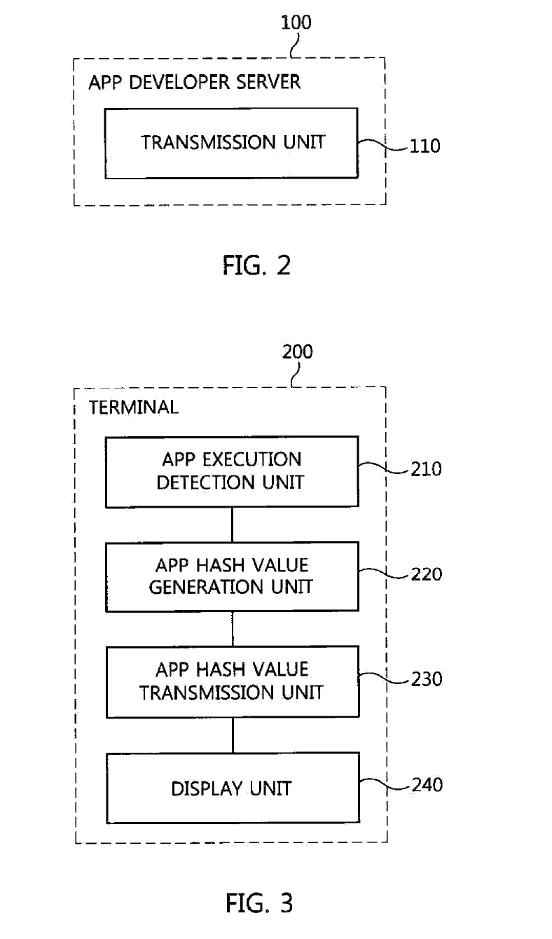

Next, the App developer server will be described in detail with reference to FIG. 2.

FIG. 2 is a configuration diagram schematically showing an App developer server according to an embodiment of the present invention.

Referring to FIG. 2, the App developer server 100 includes a transmission unit 110.

The transmission unit 110 transmits Apps that have been developed to the App registration server 10, and then enables the Apps to be registered in the App registration server 10.

FIG. 3 is a configuration diagram schematically showing a terminal according to an embodiment of the present invention.

Referring to FIG. 3, the terminal 200 includes an App execution detection unit 210, an App hash value generation unit 220, an App hash value transmission unit 230, and a display unit 240.

The App execution detection unit 210 detects an Application (App) being executed by a user, that is, manually, or being automatically executed.

The App hash value generation unit 220 generates hash values of the executed App and data corresponding to the App.

The App hash value transmission unit 230 transmits the App hash values generated by the App hash value generation unit 220 to the App integrity verification apparatus 300.

The display unit 240 receives the results of App integrity verification, corresponding to the App hash values transmitted from the App hash value transmission unit 230, from the App integrity verification apparatus 300 and displays the results of App integrity verification.

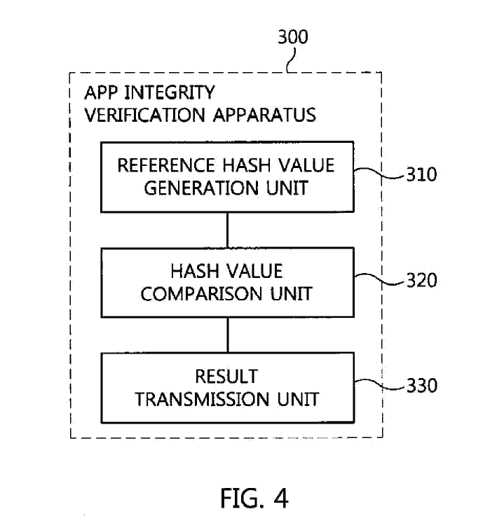

Below, the App integrity verification apparatus will be described in detail with reference to FIG. 4.

FIG. 4 is a configuration diagram showing the App integrity verification apparatus according to an embodiment of the present invention.

Referring to FIG. 4, the App integrity verification apparatus 300 includes a reference hash value generation unit 310, a hash value comparison unit 320, and a result transmission unit 330.

When detecting that the terminal 200 accesses the App integrity verification apparatus 300, the reference hash value generation unit 310 receives, from the App developer server 100, initial values (e.g., an App registered in the App developer server 100 and data corresponding to the App) corresponding to an App currently being executed on the terminal 200, and generates reference hash values based on the initial values. Here, the initial values received from the App developer server 100 correspond to the App registered before the App is executed on the terminal 200, and data corresponding to the App, and are assumed not to be infected with malicious code.

The hash value comparison unit 320 compares App hash values received from the terminal 200 with the reference hash values generated by the reference hash value generation unit and then determines whether or not the App hash values are identical to the reference hash values.

The result transmission unit 330 transfers the results of verifying the integrity of the App to the terminal 200 depending on the results of the comparison by the hash value comparison unit 320, that is, the results of determining whether or not the App hash values are identical to the reference hash values.

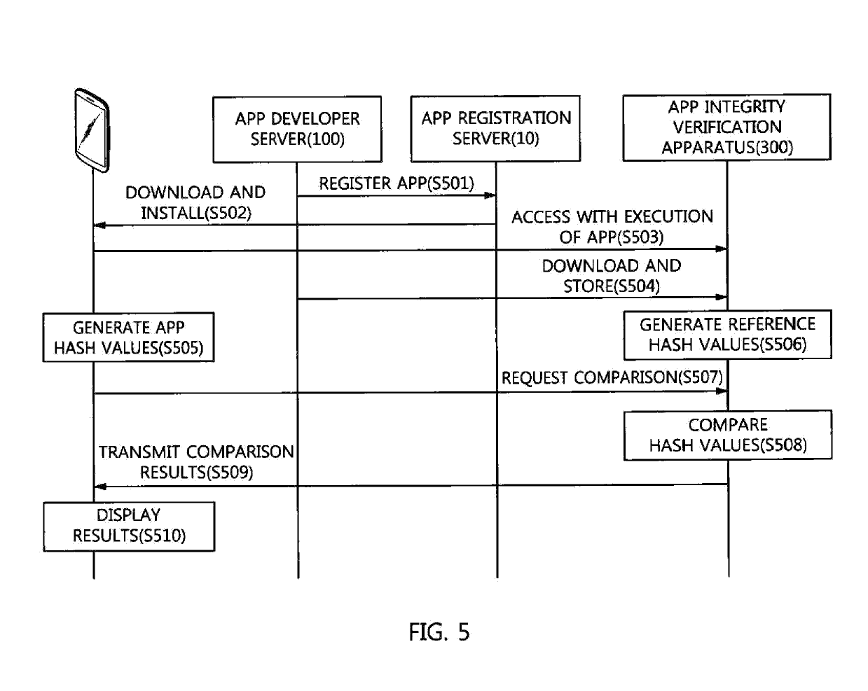

Below, with reference to FIG. 5, a description will be made in detail about a method for verifying the integrity of an App installed on a smart device using hash values of App information and related data securely stored in a cloud space, without installing an antivirus program requiring additional complicated operations on the smart device.

FIG. 5 is a flowchart showing a method for verifying the integrity of Apps according to an embodiment of the present invention.

Referring to FIG. 5, in an environment to which the App integrity verification method according to the embodiment of the present invention is applied, a terminal 200, an App developer server 100, an App registration server 10, and an App integrity verification apparatus 300 are located.

The App developer server 100 registers an App that has been developed in a reliable system, that is, the App registration server 10, at step S501.

The terminal 200 of a user downloads a specific App from the App registration server 10 and installs the App at step S502. Next, as the App installed at step S502 is executed, the terminal 200 accesses a cloud system corresponding to the App or the terminal itself, that is, the App integrity verification apparatus 300, at step S503.

When detecting that the terminal 200 accesses the App integrity verification apparatus 300, the App integrity verification apparatus 300 downloads initial values (e.g., the App registered in the App developer server 100 and data corresponding to the App) corresponding to the App that is currently being executed on the terminal 200 from the App developer server 100, and stores the initial values at step S504. At step S504, the App integrity verification apparatus 300 downloads the App currently being executed on the terminal 200 and data corresponding to the App from the App developer server 100 and then synchronizes with the terminal 200.

The terminal 200 executes the App installed at step S502, and generates hash values of the executed App and data corresponding to the App, that is, App hash values, at step S505.

The App integrity verification apparatus 300 generates reference hash values based on the App downloaded from the App developer server 100 at step S504 and data corresponding to the App at step S506. Here, the App received from the App developer server 100 corresponds to the App registered before the App is executed on the terminal 200, and is assumed not to be infected with malicious code.

The terminal 200 delivers a message requesting the comparison of the App hash values generated at step S505 with the reference hash values enabling the verification of App integrity, together with the App hash values, to the App integrity verification apparatus 300 at step S507.

The App integrity verification apparatus 300 compares the App hash values, which are received together with the comparison request from the terminal 200 at step S507, with the reference hash values, which are generated at step S505, at step S508. Next, the App integrity verification apparatus 300 transfers the results of verifying the integrity of the App to the terminal 200 depending on the results of the comparison at step S508, that is, the results of determining whether or not the App hash values are identical to the reference hash values, to the terminal 200 at step S509.

More specifically, if the App hash values are identical to the reference hash values, the App integrity verification apparatus 300 determines that the App has integrity. In contrast, if the App hash values are not identical to the reference hash values, the App integrity verification apparatus 300 determines that the App does not have integrity.

The terminal 200 displays the App integrity verification results, received at step S509, at step S510.

In this way, the App integrity verification method according to the embodiment of the present invention may verify the integrity of Apps installed on a smart device using the hash values of App information and related data securely stored in a cloud space, without installing an antivirus program requiring additional complicated operations on the smart device.

In accordance with the present invention, the App integrity verification apparatus and method may verify the integrity of Apps installed on a smart device using the hash values of App information and related data securely stored in a cloud space, without installing an antivirus program requiring additional complicated operations on the smart device, thus reducing the consumption of battery power caused by the installation and execution of antivirus programs and minimizing the consumption of memory capacity.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A method for verifying integrity of applications (Apps), comprising:
when a terminal accesses the application integrity verification apparatus, receiving at least one initial value corresponding to an application currently being executed on the terminal from a given application developer server and then generating at least one reference hash value;
receiving, from the terminal, at least one application hash value generated based on the application currently being executed on the terminal and data corresponding to the application;
comparing the reference hash value with the application hash value; and
verifying integrity of the application based on results of the comparison between the reference hash value and the application hash value.

2. The method of claim 1, wherein generating the reference hash value comprises generating the reference hash value using an initial value corresponding to an application that is not infected with malicious code.

3. The method of claim 1, wherein verifying the integrity of the application comprises, if the reference hash value is identical to the application hash value, determining that the application has integrity.

4. The method of claim 1, wherein verifying the integrity of the application comprises, if the reference hash value is not identical to the application hash value, determining that the application does not have integrity.

5. The method of claim 1, wherein verifying the integrity of the application comprises providing results of verifying the integrity of the application to the terminal.

6. An apparatus for verifying integrity of applications, comprising:
a reference hash value generation unit for receiving at least one initial value corresponding to an application currently being executed on a terminal from a given application developer server and then generating at least one reference hash value; and
a hash value comparison unit for comparing at least one application hash value received from the terminal with the reference hash value, and verifying integrity of the application currently being executed on the terminal based on results of the comparison.

7. The apparatus of claim 6, wherein the reference hash value generation unit generates the reference hash value using an initial value corresponding to an application that is not infected with malicious code.

8. The apparatus of claim 6, wherein the hash value comparison unit is configured to if the reference hash value is identical to the application hash value, determine that the application has integrity.

9. The apparatus of claim 6, wherein the hash value comparison unit is configured to, if the reference hash value is not identical to the application hash value, determine that the application does not have integrity.

10. The apparatus of claim 6, further comprising a result transmission unit for providing, from the hash value comparison unit, results of verifying the integrity of the application currently being executed on the terminal to the terminal.

11. The apparatus of claim 6, wherein the hash value comparison unit receives, from the terminal, the application hash value generated based on the application currently being executed on the terminal and data corresponding to the application.
